(19) United States
(12) Patent Application Publication
(10) Pub. No.: US 2019/0231626 A1
(43) Pub. Date: Aug. 1, 2019

(54) Airway Bridge and Method for Using the Same

(71) Applicant: Steve Islava, Newport Beach, CA (US)

(72) Inventor: Steve Islava, Newport Beach, CA (US)

(21) Appl. No.: 15/884,051

(22) Filed: Jan. 30, 2018

(51) Int. Cl. A61G 13/12; A61G 13/10; A61G 13/08; A61H 31/00

(52) U.S. Cl. CPC A61G 13/1215; A61H 31/007; A61G 13/08; A61G 13/105

(57) ABSTRACT

A device and method for performing cardiopulmonary resuscitation (CPR) on a patient. The device is an extendable airway bridge which is initially in a collapsed or storage configuration. The airway bridge is made of a lightweight, inexpensive material such as high strength cardboard. Upon use, the airway bridge is unfolded and then fixed into an operating configuration through a number of hook and latch fabric portions or an adhesive or glue. Once in the operating configuration, the patient is laid onto the airway bridge which holds the patient in a position so as to prevent occlusion of the patient's oral airway. CPR may then be performed on the patient. After use, the airway bridge may be released and then brought back into the collapsed or storage configuration or, alternatively, simply disposed of.

### BACKGROUND

### Field of the Technology

The invention relates to the field of cardiopulmonary resuscitation (CPR), specifically to apparatuses and methods for quickly stabilizing the head and neck of a patient for improved performance of cardiopulmonary resuscitation (CPR).

### Description of the Prior Art

Cardiopulmonary resuscitation or CPR has long been used to reinstate or preserve blood flow through a patient until further medical treatment arrives or can be implemented. CPR principally comprises a series of chest compressions delivered by hand followed by a volume of air being forced into the patient's airway through mouth to mouth resuscitation or through a one-way valve disposed in a mask that is placed on the patient. Compressing the patient's chest raises the patient's blood pressure so that organs such as the brain continue to receive blood flow while air forced into the patient's lungs forces them to respire for an extended amount of time over what would have occurred had no assistance been given. When CPR was first implemented as a treatment regimen, the initial proscribed method included ventilating the patient once for every five chest compressions. This was later changed to ventilate the patient twice for every ten chest compressions. Modernly however, the preferred CPR treatment regime includes two ventilations for every thirty chest compressions.

Regardless of the ratio of chest compressions to ventilations however, in order for CPR to be truly effective, the oral airway of the patient must remain accessible and free of occlusions. This can be particularly difficult when the patient is severely injured or when the patient's tongue is otherwise blocking or occluding the patient's oral airway thus preventing effective patient ventilation. This can be especially critical in emergency situations when every moment that the patient is denied blood flow or oxygen dramatically increases the odds of stroke or even death. Previous airway bridges that have been used include molds which are used to prop the patient's shoulders and neck in an upward position. With the airway bridge properly placed, the patient's head is tilted backward, thus clearing the patient's oral airway for proper ventilation. These airway bridges are typically comprised of foam and are vacuum packed and sealed within the EMT's medical equipment in order to save space. Frequently however during transit to the accident site, these vacuum packed airway bridges can have their seal broken or removed, thus causing the foam of the airway bridge to prematurely expand within its packaging. Thus when the EMT retrieves the airway bridge for use on a patient, the airway bridge can be difficult to remove from its packaging, thus delaying treatment of the patient even further.

What is needed therefore is an apparatus and method for quickly and efficiently supporting and clearing a patient's airway for CPR treatment or other treatments requiring access to the patient's oral airway while the patient is still present at the scene of the emergency. The apparatus should be easily transported and stored while also being inexpensive, disposable, and easy to use.

### BRIEF SUMMARY

The current invention is an airway bridge for maintaining a patient at an elevated position. The airway bridge includes a base, an incline portion adjustably coupled to the base, a vertical portion adjustably coupled to the incline portion, and a brace portion adjustably coupled to the vertical portion. The airway bridge also includes a first adhering means disposed on a top surface of the base and a corresponding second adhering means disposed on a bottom surface of the brace portion, the second adhering means being configured to removably couple to the first adhering means.

In one embodiment, the airway bridge includes a stop that is coupled to the lateral edge of the base, wherein the stop is disposed at a lateral edge of the base. In this embodiment, the various portions of the airway bridge including the base, the incline portion, the vertical portion, the brace portion, and the stop are comprised of rigid lightweight material.

In a separate embodiment, the incline portion, the vertical portion, and the brace portion of the airway bridge are capable of being placed into a parallel position relative to the base when the airway bridge is in a collapsed configuration.

In a related embodiment, the base, the incline portion, the vertical portion, and the brace portion of the airway bridge are formed from a single structural body.

In yet another embodiment, the incline portion, the vertical portion, and the brace portion of the airway bridge are capable of being placed into a co-planar position relative to the base when the airway bridge is in an expanded configuration.

In yet another embodiment, the first adhering means and the second adhering means of the airway bridge are preferably comprised of a plurality of corresponding surfaces of hook and latch fabric.

In one particular embodiment, the incline portion of the airway bridge is disposed at an angle of between 45-60 degrees relative to the base when the airway bridge is in the operating configuration. The stop in this embodiment is further configured to prevent the lateral movement of the brace portion after the airway bridge has been placed into the operating configuration.

The invention further provides a method for actuating an airway bridge. The method includes manipulating an incline portion of the airway bridge to be disposed at an angle relative to a base of the airway bridge, manipulating a vertical portion of the airway bridge to be disposed perpendicular relative to the base of the airway bridge, and coupling a brace portion of the airway bridge to the base of the airway bridge. The method further includes preventing any lateral movement of the brace portion after it has been coupled to the base.

In one embodiment, the method step of preventing any lateral movement of the brace portion after it has been coupled to the base involves coupling the brace portion adjacent to a stationary stop coupled to the base.

In a separate embodiment, the method step of coupling a brace portion of the airway bridge to the base of the airway bridge involves pressing at least one portion of hook and latch fabric disposed on the bottom surface of the brace portion against a corresponding portion of hook and latch fabric disposed on a top surface of the base.

In yet another embodiment, the method step of manipulating an incline portion of the airway bridge to be disposed at an angle relative to a base of the airway bridge includes adjusting the incline portion to be disposed at an angle between 45-60 degrees relative to the base of the airway bridge.

In a further embodiment, the method also includes releasing the brace portion from the base of the airway bridge, manipulating the brace portion, the vertical portion, and the incline portion to be disposed parallel to the base of the airway bridge, and reducing the relative angle between the incline portion and the base to a minimum.

In a different embodiment, the method also includes releasing the brace portion from the base of the airway bridge, manipulating the brace portion, the vertical portion, and the incline portion to be disposed in a common plane with the base of the airway bridge, and then increasing the relative angle between the incline portion and the base to a maximum.

The invention further provides a method for performing cardiopulmonary resuscitation (CPR) on a patient. The method involves providing an airway bridge in a collapsed configuration, moving the airway bridge from the collapsed configuration into an operating configuration, and then fixing the airway bridge in the operating configuration. Next, the patient is placed onto the airway bridge and CPR is performed. The airway bridge is then removed from the vicinity of the patient.

In one embodiment, the method step of moving the airway bridge from the collapsed configuration into an operating configuration includes manipulating an incline portion of the airway bridge from a parallel position relative to a base of the airway bridge to an angled position relative to the base of the airway bridge.

In another embodiment, the method step of fixing the airway bridge in the operating configuration comprises removably coupling a brace portion of the airway bridge to a base of the airway bridge.

In yet another embodiment, the method step of placing the patient onto the airway bridge includes laying the shoulders of the patient on an incline portion of the airway bridge while the head of the patient rests on a brace portion and a stop of the airway bridge. The incline portion of the airway bridge is disposed at an angle relative to the brace portion and stop of the airway bridge so that when the patient is undergoing CPR, their head reclines at an angle thus prevent occlusion of their oral airway.

In another embodiment, the method step of fixing the airway bridge in the operating configuration comprises placing a brace portion of the airway bridge laterally against a fixed stop disposed on the base of the airway bridge.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a side view of the current airway bridge when it has been assembled into an operating configuration.

FIG. 2 is a side view of the airway bridge seen in FIG. 1 when it is in a storage configuration.

FIG. 3 is a perspective view of the airway bridge while in the storage configuration seen in FIG. 2.

FIG. 4 is a perspective view of the airway bridge while in the operating configuration seen in FIG. 1.

FIG. 5 is a magnified top down view of a first set of adhering means of the airway bridge.

FIG. 6 is a top down view of the airway bridge while in the operating configuration seen in FIG. 1.

FIG. 7 is a top down view of the airway bridge while in an expanded configuration.

FIG. 8 is a frontal view of the airway bridge while in the operating configuration seen in FIG. 1.

FIG. 9 is a side view of the airway bridge as it is being assembled into the operating configuration seen in FIG. 1.

FIG. 10 is a side view of a patient using the airway bridge seen in FIG. 1.

FIG. 11 is a side view of a patient using the airway bridge while CPR is being performed on the patient.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

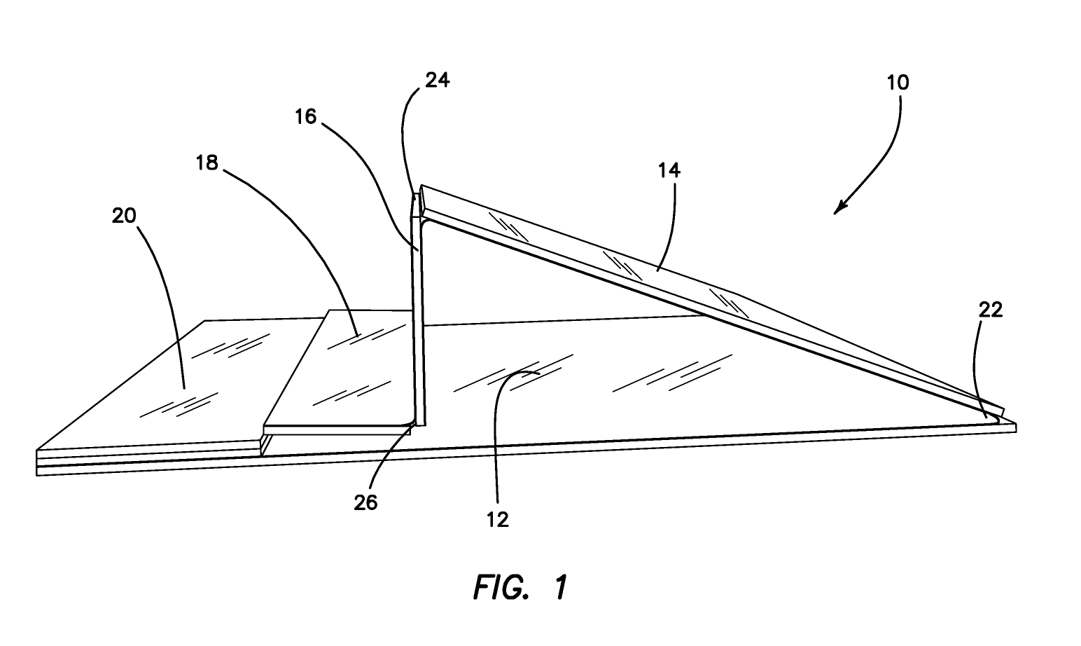

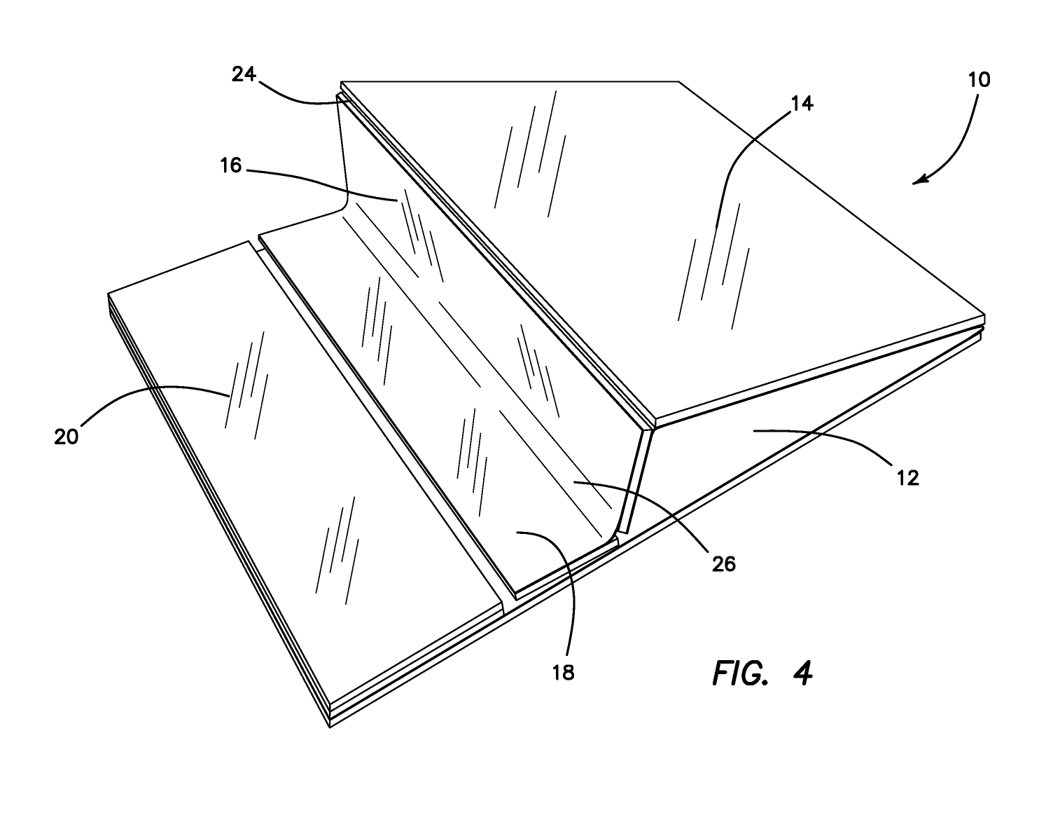

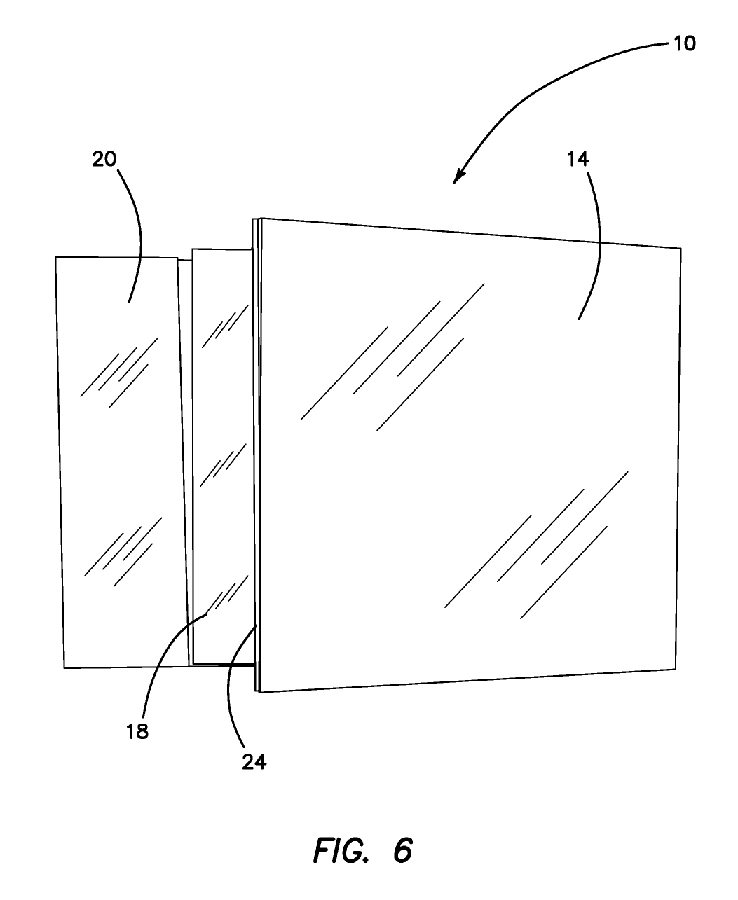

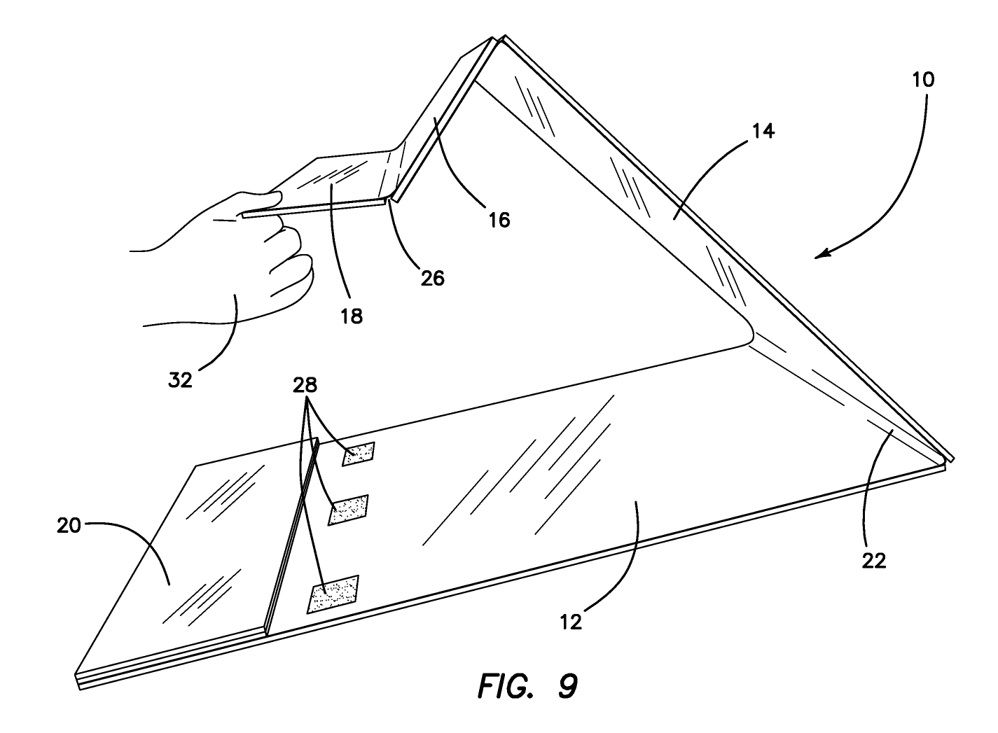

The current invention is an adjustable and collapsible rigid airway bridge which is seen in FIGS. 1-9 and is generally denoted by reference numeral 10. In FIGS. 1, 4, 6, and 8, the airway bridge 10 is seen in a fully actuated or operating position, namely a configuration which is configured to receive a patient. In one embodiment, the airway bridge 10 comprises a base portion 12 and an incline portion 14 coupled together via a first joint 22 at a proximal edge of the incline portion 14. Coupled to the opposing distal edge of the incline portion 14 at a second joint 24 is a vertical portion 16. In turn, at the opposing edge of the vertical portion 16 is a third joint 26 coupled to a brace portion 18. Additionally coupled to the base 12 is at least one stop 20, preferably disposed at the very edge of one end of the base 12 as best seen in FIGS. 1 and 4. The surface elements of the airway bridge 10, namely the base 12, the incline 14, the vertical portion 16, the brace 18, and the stop 20 are preferably comprised of a substantially rigid yet lightweight material such as plastic, cardboard, aluminum, or wood, however other similar materials now known or later devised may be used without departing from the original spirit and scope of the invention. The joints 22, 24, 26 in turn are preferably comprised of a flexible yet durable material such as nylon, leather, plastic composites, or other similar materials.

In one particular embodiment, each surface element of the airway bridge 10 including the base 12, incline 14, vertical portion 16, brace 18, and stop 20 each comprise a graphic or image disposed across its respective surface. For example, the incline 14 may contain a graphic which comprises an image or a series of images depicting how to use the airway bridge 10 on a patient or how to perform CPR. The brace 18 and stop 20 may further comprise an image which shows where the user is to place the head of the patient as the patient is being lowered onto the airway bridge 10. The image disposed across the brace 18 and the stop 20 can cooperate and form a larger image which, when the brace 18 is adhered to the base 12, ensures that the brace 18 is properly aligned with the stop 20.

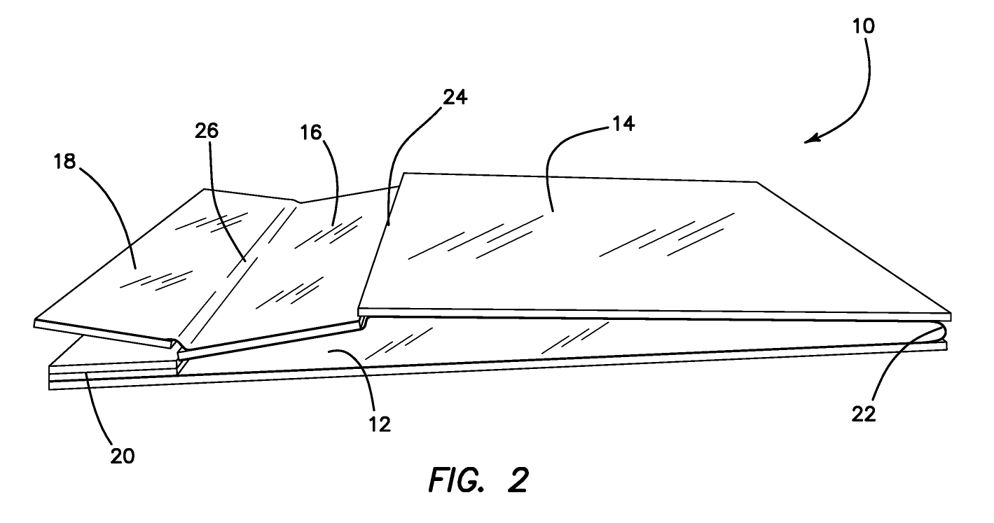

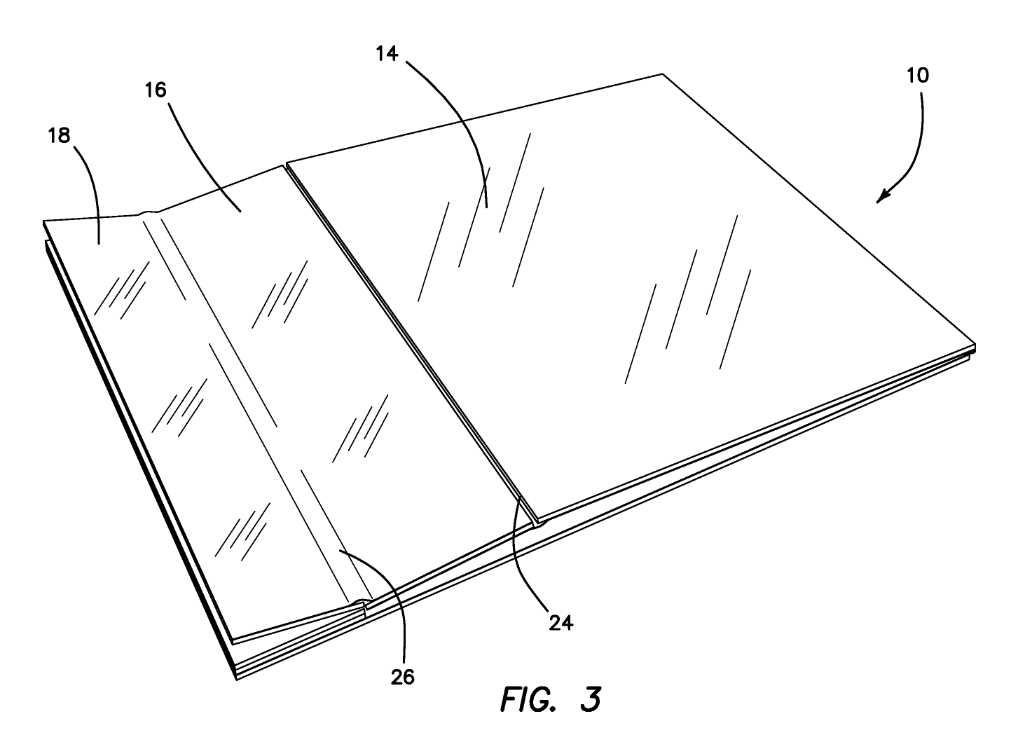

In FIGS. 2 and 3, the airway bridge 10 is seen in a collapsed or storage configuration wherein the airway bridge 10 is substantially flat and/or rectangular in shape that is ideal for storage or mobile transport. As seen in FIGS. 2 and 3, the incline portion 14, vertical portion 16, and brace 18 are laid flat against the base 12 and stop 20 by bending the first joint 22 a maximum amount so that incline portion 14, vertical portion 16, and brace 18 rest against the base 12 and stop 20, respectively. With the airway bridge 10 in this configuration, the airway bridge 10 has a minimum thickness which allows a plurality of airway bridges 10 to be stacked on one another or placed into a medical equipment bag or storage case while still maintaining a minimum volume.

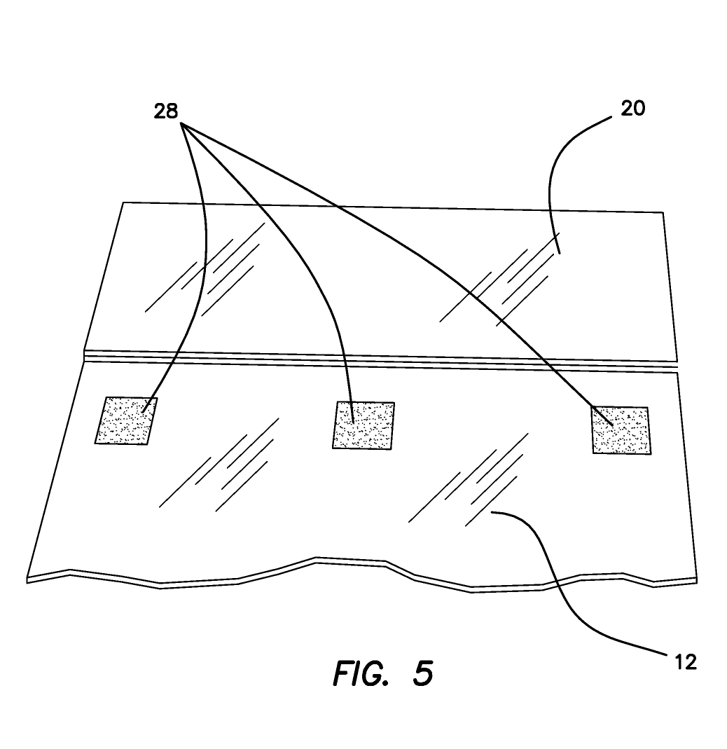

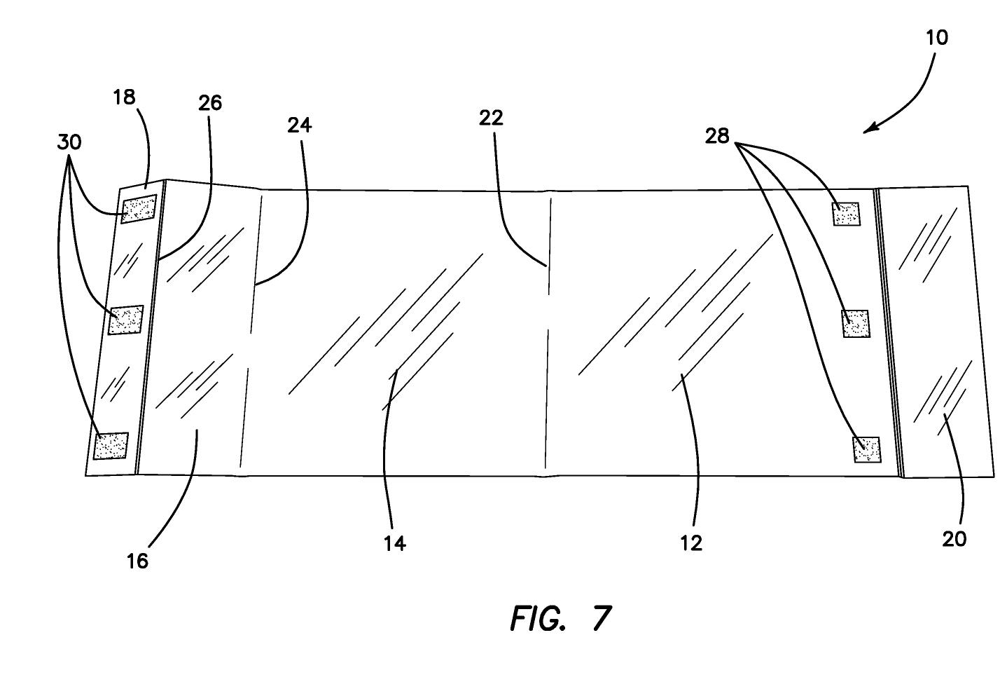

In FIGS. 5 and 7, the airway bridge 10 is seen in an unfolded or expanded configuration wherein the airway bridge 10 is substantially flat but in an elongated or extended shape as compared to the shape seen in FIGS. 2 and 3. As seen in FIGS. 5 and 7, the airway bridge 10 is principally a single structural body or component divided by a plurality of joints or flexible portions there between. In FIG. 7 the first joint 22 is bent to a minimum so that the incline portion 14, vertical portion 16, and brace 18 lay flat on the same plane as the base 12. Also seen in FIGS. 5 and 7 are the first adhering means 28 and the second adhering means 30. The first adhering means 28 are coupled to an upward facing surface of the base 12, while the second adhering means 30 are coupled to a downward facing surface of the brace 18. As seen in FIGS. 5 and 7, the first adhering means 28 and second adhering means 30 are corresponding portions or sections of hook and loop fabric. However the first and second adhering means 28, 30 may be any means for temporarily coupling the downward facing surface of the brace 18 to the upward facing surface of the base 12 including but not limited to hook and latch fabric, snap buttons, adhesive or glue, magnets, or the like. In FIG. 5 specifically, the first adhering means 28 is shown as being three distinct elements disposed uniformly across the width of the base 12, however it is to be expressly understood that fewer or additional elements may be disposed across the base 12 in configurations not explicitly shown without departing from the original spirit and scope of the invention.

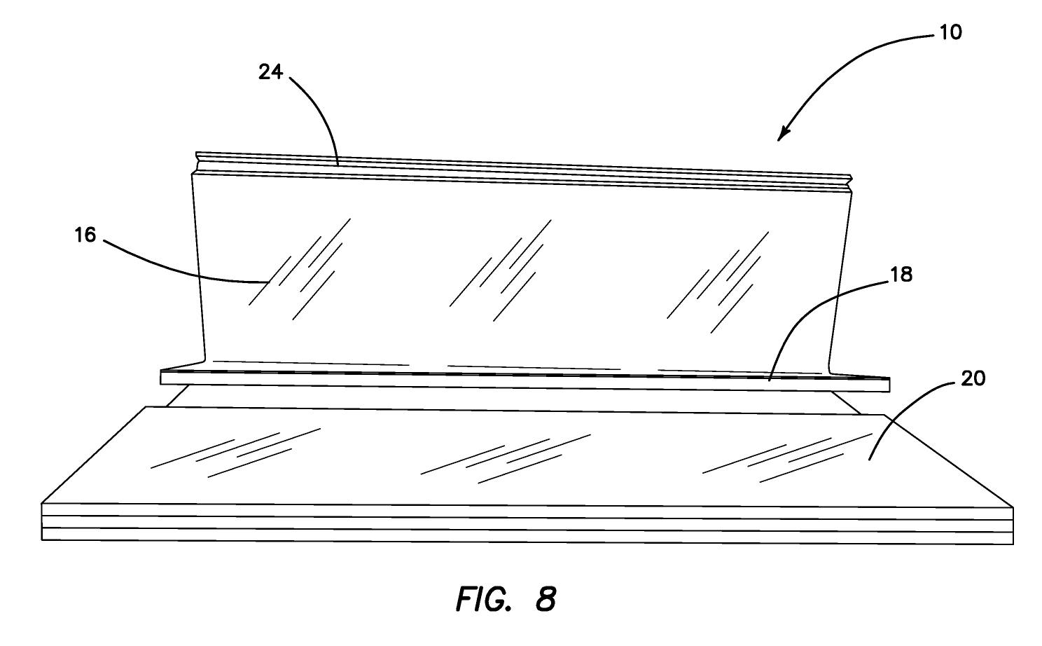

To use the airway bridge 10, a user removes the airway bridge 10 from its storage location while it is in its folded configuration seen in FIGS. 2 and 3. The user 32 then places the airway bridge 10 on a flat surface. Next the user 32 lifts the incline portion 14 by gripping the brace 18 and lifting upwards, bending the airway bridge 10 at the first joint 22. The user 32 then further manipulates the airway bridge 10 by bending the airway bridge 10 at the second joint 24 and third joint 26 as best seen in FIG. 8. The user 32 then guides the brace portion 18 down against the base 12 so that the distal edge of the brace 18 is adjacent to or makes contact with the at least one stop 20 as seen in FIGS. 1, 4, and 8. The user 32 then ensures that the second adhering means 30 is in contact or has otherwise coupled with the corresponding first adhering means 28 disposed on the base 12 by pressing the brace 18 against the base 12 or otherwise joining the brace 18 and base 12 together. With the brace 18 correctly placed on the base 12 and adjacent to the stop 20, the brace 18 will be parallel to the base 12, while the vertical portion 16 will be vertical or perpendicular to the base 12 as seen in FIG. 1. Additionally, after the brace 18 has been coupled to the base 12, the incline 14 is disposed at an angle of preferably 45-60° relative the base 12, however the incline 14 may be held at other angles not explicitly disclosed without departing from the original spirit and scope of the invention.

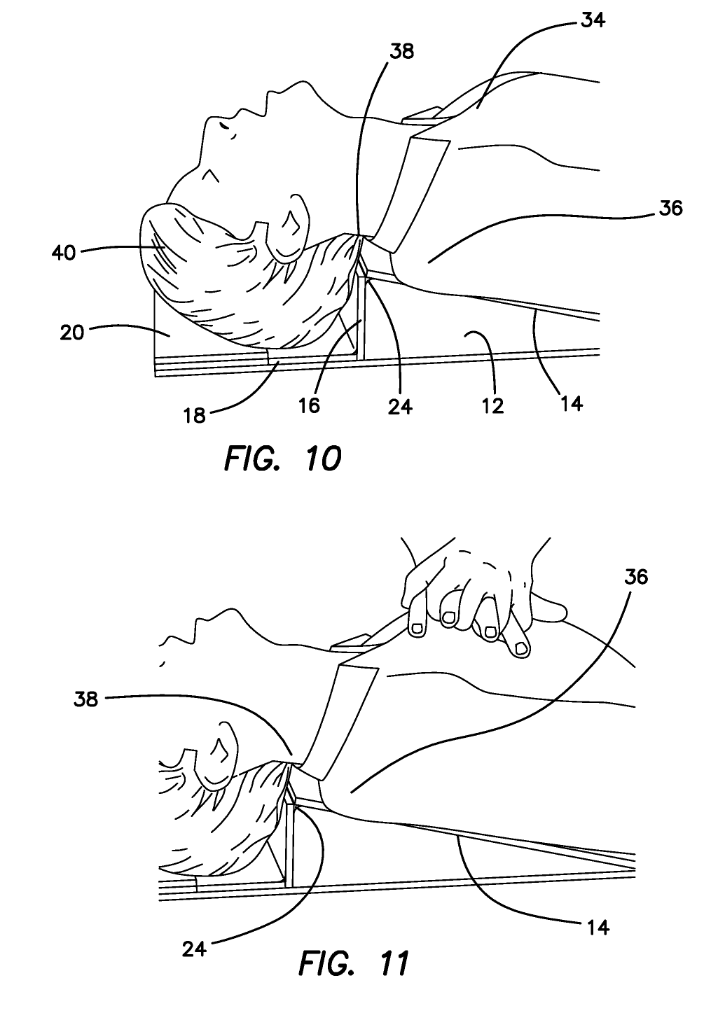

With the brace 18 correctly placed, the airway bridge 10 is ready for use by a patient 34. In one embodiment, the patient 34 is laid down on top of the airway bridge 10 as seen in FIG. 10 with the top portion of their shoulders 36 on the incline 16 and the base of their neck 38 at the second joint 24. The patient's head 40 is then allowed to rest on the remaining portions of the airway bridge 10, namely the top surface of the brace 18 and stop 20. Having the patient's head 40 rest at a lower position than their shoulders 36 inherently angles the patient's head 40 upwards and naturally opens up the patient's oral cavity and thus makes the patient's oral airway easier to access. Additionally, because the patient's head 40 is tilted backwards, the tongue of the patient tends to stay out of the patient's airway thus lowering the probability of the patient's airway becoming occluded. In another embodiment, the patient 34 may be laying on a flat surface beforehand and the assembled airway bridge 10 as seen in FIG. 1 may be slid or forced underneath the patient 34. After the patient has been disposed or placed on top of the airway bridge 10, the user or EMT may perform CPR as seen in FIG. 11 with enhanced access to the patient's oral airway. When in use, the combined weight of the patient and the force from the chest compressions performed by the EMT pushes the brace 18 against the stop 20, thus preventing the brace 18 from sliding laterally and collapsing the airway bridge 10.

After the patient 34 has been treated or moved off of the airway bridge 10, the airway bridge 10 may be collapsed and/or folded by releasing the second adhering means 30 from the first adhering means 28 and lifting the brace 18 upwards away from the base 12. The brace and incline 14 may be manipulated about the first, second, and third joints 22, 24, 26 by the user 32 so that the incline 14, vertical portion 16, and brace 18 are then laid flat or parallel against the stop 20 and base 12 as seen in FIGS. 2 and 3. At this point the airway bridge 10 may be returned to its storage container or simply disposed of by the user.

In an alternative embodiment, the airway bridge 10 comprises a pull tab or other means for actuation which quickly moves the airway bridge 10 from the compact configuration seen in FIG. 2 to the actuated configuration seen in FIG. 1. After placing the airway bridge 10 on a flat surface, the user 32 pulls the pull tab or otherwise activates the actuation means which quickly and automatically brings or pulls the incline 14 to an angled position relative to the base 12 and simultaneously brings the brace 18 to a position adjacent to the stop 20 as seen in FIG. 1. To release or collapse the airway bridge 10 after use, the user 32 may decouple the first and second adhering means 28, 30 from each other as discussed above, or alternatively, the user 32 may actuate a pull tab to collapse the airway bridge 10, either the same pull tab which originally activated the airway bridge 10 or a separate pull tab which is configured for that purpose.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. An airway bridge for maintaining a patient at an elevated position comprising:
a base;
an incline portion adjustably coupled to the base;
a vertical portion adjustably coupled to the incline portion;
a brace portion adjustably coupled to the vertical portion;
a first adhering means disposed on a top surface of the base; and
a second adhering means disposed on a bottom surface of the brace portion, wherein the second adhering means is configured to removably couple to the first adhering means.

2. The airway bridge of claim 1 further comprising a stop coupled to the base, wherein the stop is disposed at a lateral edge of the base.

3. The airway bridge of claim 2 wherein the base, the incline portion, the vertical portion, the brace portion, and the stop are comprised of rigid lightweight material.

4. The airway bridge of claim 1 wherein the incline portion, the vertical portion, and the brace portion are capable of being placed into a parallel position relative to the base when the airway bridge is in a collapsed configuration.

5. The airway bridge of claim 1 wherein the base, the incline portion, the vertical portion, and the brace portion are formed from a single structural body.

6. The airway bridge of claim 1 wherein the incline portion, the vertical portion, and the brace portion are capable of being placed into a co-planar position relative to the base when the airway bridge is in an expanded configuration.

7. The airway bridge of claim 1 wherein the first adhering means and the second adhering means are comprised of a plurality of corresponding surfaces of hook and latch fabric.

8. The airway bridge of claim 1 wherein the incline portion is disposed at an angle of between 45-60 degrees relative to the base when the airway bridge is in an operating configuration.

9. The airway bridge of claim 2 wherein the stop is configured to prevent the lateral movement of the brace portion when the airway bridge is in an operating configuration.

10. A method for actuating an airway bridge comprising:
manipulating an incline portion of the airway bridge to be disposed at an angle relative to a base of the airway bridge;
manipulating a vertical portion of the airway bridge to be disposed perpendicular relative to the base of the airway bridge;
coupling a brace portion of the airway bridge to the base of the airway bridge; and
preventing any lateral movement of the brace portion after it has been coupled to the base.

11. The method of claim 10 wherein preventing any lateral movement of the brace portion after it has been coupled to the base comprises coupling the brace portion adjacent to a stationary stop coupled to the base.

12. The method of claim 10 wherein coupling a brace portion of the airway bridge to the base of the airway bridge comprises pressing at least one portion of hook and latch fabric disposed on the bottom surface of the brace portion against a corresponding portion of hook and latch fabric disposed on a top surface of the base.

13. The method of claim 10 wherein manipulating an incline portion of the airway bridge to be disposed at an angle relative to a base of the airway bridge comprises adjusting the incline portion to be disposed at an angle between 45-60 degrees relative to the base of the airway bridge.

14. The method of claim 10 further comprising:
releasing the brace portion from the base of the airway bridge;
manipulating the brace portion, the vertical portion, and the incline portion to be disposed parallel to the base of the airway bridge; and
reducing the relative angle between the incline portion and the base to a minimum.

15. The method of claim 10 further comprising:
releasing the brace portion from the base of the airway bridge;
manipulating the brace portion, the vertical portion, and the incline portion to be disposed in a common plane with the base of the airway bridge; and
increasing the relative angle between the incline portion and the base to a maximum.

16. A method for performing cardiopulmonary resuscitation (CPR) on a patient comprising:
providing an airway bridge in a collapsed configuration;
moving the airway bridge from the collapsed configuration into an operating configuration;
fixing the airway bridge in the operating configuration;
placing the patient onto the airway bridge;
performing CPR on the patient; and
removing the airway bridge from the patient.

17. The method of claim 16 wherein moving the airway bridge from the collapsed configuration into an operating configuration comprises manipulating an incline portion of the airway bridge from a parallel position relative to a base of the airway bridge to an angled position relative to the base of the airway bridge.

18. The method of claim 16 wherein fixing the airway bridge in the operating configuration comprises removably coupling a brace portion of the airway bridge to a base of the airway bridge.

19. The method of claim 16 wherein placing the patient onto the airway bridge comprises laying the shoulders of the patient on an incline portion of the airway bridge and the head of the patient on a brace portion and a stop of the airway bridge, wherein the incline portion of the airway bridge is disposed at an angle relative to the brace portion and stop of the airway bridge.

20. The method of claim 16 wherein fixing the airway bridge in the operating configuration comprises placing a brace portion of the airway bridge laterally against a fixed stop disposed on the base of the airway bridge.
